(19) United States
(12) Patent Application Publication
(10) Pub. No.: US 2011/0106396 A1
(43) Pub. Date: May 5, 2011

(54) METHOD AND CONTROLLER FOR CHECKING AN EXHAUST GAS AFTERTREATMENT SYSTEM OF AN INTERNAL COMBUSTION ENGINE

(75) Inventors: Harald Moll, Ulm-Einsingen (DE); Damien Bouvier, Stuttgart (DE)

(73) Assignee: Robert Bosch GMBH, Stuttgart (DE)

(21) Appl. No.: 12/812,884

(22) PCT Filed: Dec. 17, 2008
(86) PCT No.: PCT/EP2008/067687

§ 371 Date: Jan. 17, 2011

(30) Foreign Application Priority Data
Jan. 14, 2008 (DE) 10 2008 004 207.2

(51) Int. Cl. F02D 28/00; G06F 19/00

(52) U.S. Cl. 701/102; 702/24

(57) ABSTRACT

The invention relates to a method for checking the operability of an exhaust gas after-treatment system (12) of an internal combustion engine by evaluating signals (S_{—}22, S_{—}26) of a first exhaust gas sensor (22) and a second exhaust gas sensor (S_{—}26), between which a catalyst 24 is disposed. The method is characterized in that the air ratio L of an exhaust gas atmosphere flowing through the exhaust gas after-treatment system (12) is reduced from a first lambda value 11>1 to a third lambda value L3 with L2>L3 via a second lambda value L2 with L1>L2>1, the value of a time duration (dt_{—}26; dt_{—}22) is detected, which is between the times (t5, t6, 7t7, t8) at which the signals (S_{—}26, S_{—}22) of the two exhaust gas sensors (22, 26) display the second value L2, the value of the time duration (dt_{—}26; dt_{—}22) is compared to a threshold value (dt_max), and an analysis of the operability of the catalyst (24) is not carried out if the value of the time duration (dt_{—}26; dt_{—}22) is greater than the threshold value. The invention further relates to a controller configured for carrying out the method.

### STATE OF THE ART

The invention relates to a method for checking the functionality of an exhaust gas after-treatment system of a combustion engine according to the generic term of claim 1. The invention relates furthermore to a control unit according to the generic term of claim 9. Such a method and such a control unit are both known from the publication “Otto engine management Motronic systems”, 1^{st} edition, April 2003, ISBN: 3-7782-2029-2, pages 56 to 58.

Such an exhaust gas after-treatment system provides in particular a catalytic converter, which is arranged between a first exhaust gas probe and a second exhaust gas probe. Such a catalytic converter can be a NOx storage catalytic converter. It is know from such arrangements to create alternatively oxidizing and reducing exhaust gas atmospheres. At an oxidizing exhaust gas atmosphere the catalytic converter stores oxygen and/or nitrous gases, depending on the type of the catalytic converter. At an reducing exhaust gas atmosphere the catalytic converter releases the previously stored oxygen as a component of water and CO2, whereby the second exhaust gas probe temporarily shows an air ratio λ=1. The second exhaust gas probe shows a reduced exhaust gas atmosphere not until the oxygen that is stored in the catalytic converter has been consumed. At an oxidizing exhaust gas atmosphere the second exhaust gas probe displays an air ratio λ=1 so long until the storage compatibility of the catalytic converter is depleted. Only then the second exhaust gas probe shows an oxidizing exhaust gas atmosphere.

The first exhaust gas probe shows the change between oxidizing and reducing exhaust gas atmosphere on the other without such delays. The delays that can be determined from the signals of the first and second exhaust gas probe correlate with the storage compatibility of the catalytic converter. The storage compatibility correlates with the functionality of the catalytic converter. The detection of the time delay from the signals of the first exhaust gas probe and the second exhaust gas probe at an almost complete filling and emptying of the catalytic converter allows therefore principally an evaluation of the functionality of the catalytic converter.

However erroneous evaluations have thereby occurred again and again. This means either that catalytic converters, which did not fulfill statutory provisions anymore, have not been detected as defect, or that catalytic converters, which have not been functional enough yet, have already been evaluated as not functional anymore.

### DISCLOSURE OF THE INVENTION

Based on this background the task of the invention is to provide a method and a control unit, which each allows a reliable evaluation of a catalytic converter. This task is used with the characteristics of the independent claims.

The invention is based on the knowledge that also delays, which are not caused by storing processes in the catalytic converter, can occur at the reaction of exhaust gas probes upon changes between different exhaust gas atmospheres, which means between exhaust gas atmospheres with different value of the air ratio lambda. Aged exhaust gas probes show the change for example as being delayed. This results in an overlapping of delays, which depend on the catalytic converter, with delays, which depend on one or both exhaust gas probes. If (only) the second exhaust gas probe reacts delayed, the time span that has to be evaluated for the catalytic converter evaluation gets longer. The catalytic converter is therefore evaluated as being principally more functional than compared to its actual functionality. Vice versa, the catalytic converter is evaluated principally as less functional, if (only) the first exhaust gas probe reacts delayed.

In this context the invention allows the detection of the cases that one of the two exhaust gas probes reacts delayed. Thereby, in that a checking of the catalytic converter does not take place in such a case, the above stated erroneous evaluations of the functionality of the catalytic converter are omitted.

Preferred embodiments allow a distinction between a delayed reacting first exhaust gas probe and a delayed reacting second exhaust gas probe. by detecting a delayed reacting second exhaust gas probe erroneously to good carried out evaluations of the catalytic converter can be omitted. By detecting a delayed reacting first exhaust gas probe erroneously carried out too bad evaluations of the catalytic converter can be omitted.

By an additional determination and evaluation of the changing speed of the signal of the first exhaust gas probe when becoming leaner from a rich exhaust gas atmosphere to a less rich exhaust gas atmosphere a delayed reacting first exhaust gas probe can additionally be recognized without a comparison with the signal of the second exhaust gas probe. Together with the comparison of the reaction of both exhaust gas probes it has the advantage that even in case both exhaust gas probes react delayed this can be detected.

An evaluation of the changing speed of the signal of the second exhaust gas probe is on the other not expressive by itself, because the changing of the speed depends strongly on the status of the catalytic converter that is arranged in front of the second exhaust gas probe. An evaluation of a lean exhaust gas atmosphere to a less lean exhaust gas atmosphere is also not expressive, because the changing speed depends strongly on the operating point of the combustion engine, which means on the exhaust gas mass current and the value of the air ratio X before becoming richer.

A particularly preferred embodiment is thereby characterized, in that the catalytic converter is a NOx storage catalytic converter. NOx catalytic converters are loaded with nitrous gases at an oxidizing exhaust gas atmosphere during the operation of the motor vehicle over a time span, whose length is located in the minute range. Subsequently they are regenerated at a reducing exhaust gas atmosphere during a time span, whose length is located in the second range. At the regeneration the nitrogen percentage of the nitrous gases is released as molecular nitrogen and the oxygen percentage of the nitrous gases as a component of water and/or CO2. The invention can be carried out at this periodically running change between oxidizing and reducing exhaust gas atmosphere without requiring additional interferences onto the air ratio λ. The checking takes therefore place only passively and has no negative effect onto the exhaust gas emissions, the fuel consumption and/or the driving behavior.

Further advantages arise from the dependent claims, the description and the attached figures.

It shall be understood that the previously mentioned characteristics and the ones that have to be explained in the following can not only be used in the stated combination but moreover in other combinations or alone without leaving the scope of the present invention.

### DRAWINGS

Embodiments of the invention are illustrated in the drawings and are further explained in the following description. It is shown in a schematic form in:

FIG. 1 the technical environment of the invention;

FIG. 2 courses of the air ratio L above the time t as they occur under different framework conditions during the regeneration of a storage catalytic converter; and

FIG. 3 a block circuit diagram of a signal processing structure of the control unit, which is construed for the implementation of an embodiment of the invention.

### EMBODIMENTS OF THE INVENTION

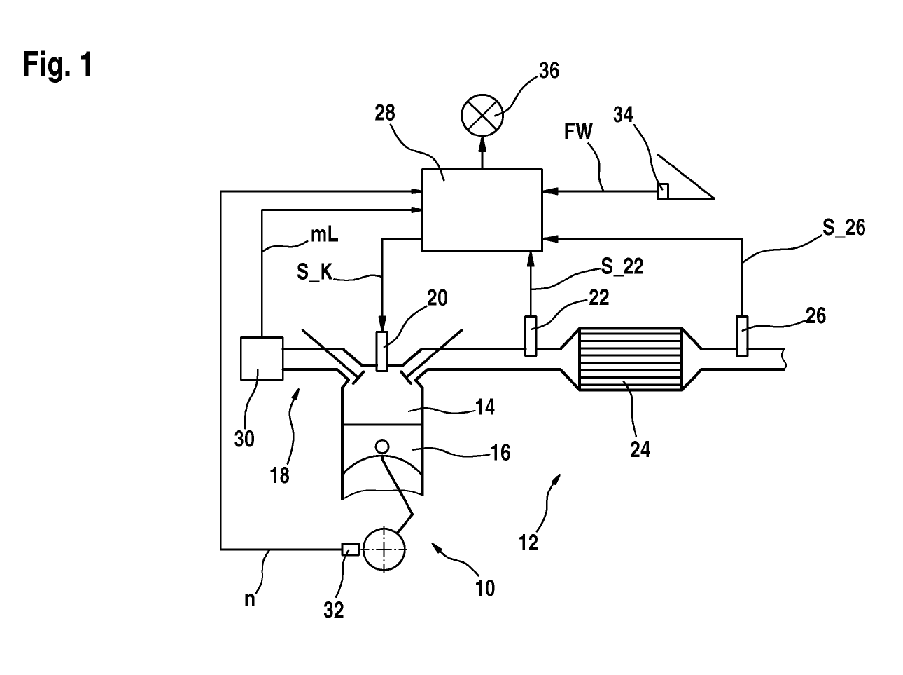

FIG. 1 shows a combustion engine 10 with an exhaust gas after-treatment system 12 in detail. The invention can principally be used independently of the combustion procedure of the combustion engine 10. At least one combustion chamber 14 of the combustion engine 10 is filled with air from an intake system 18 at a downwards running piston 16. Fuel is metered over an injection valve 20 to the filling of the combustion chamber with air. The resulting fuel/air mixture is combusted in the combustion chamber 16.

The resulting exhaust gas experienced an after-treatment in the exhaust gas after-treatment system 12 for converting pollutants as CO, HC and NO into exhaust gas components as water, molecular oxygen and CO₂. The exhaust gas after-treatment system 12 provides a first exhaust gas probe 22, which is arranged in streaming direction of the exhaust gases before the catalytic converter 24. The catalytic converter 24 can be a three-way catalytic converter or a NOx storage catalytic converter. A second exhaust gas probe 26 is arranged behind the catalytic converter 24.

The combustion engine 10 is controlled by a control unit 28, which processes therefore signals of different sensors. The control unit 28 processes in the embodiment of FIG. 1 in particular the signal mL of an air mass sensor 30, the signal of an engine speed sensor 32, the signal FW of a driver's request provider 34, the signal S_22 of the first exhaust gas probe 22 and the signal S_26 of the second exhaust gas probe 26. The control unit 28 creates from those sensor signals in particular correcting variables for controlling at least one power controlling element of the combustion engine 10. This is represented in the illustration of FIG. 1 by the signal S_K, with which the control unit 28 controls the fuel metering by controlling the injection valve 20. The control unit 28 is furthermore construed, in particular programmed, to check the functionality of the exhaust gas after-treatment system 12 according to the presented procedure. If an insufficient functionality of the exhaust gas after-treatment system 12 is detected during the checking the control unit 28 activates a malfunction indicator light 36, which informs the driver of the motor vehicle about the malfunction.

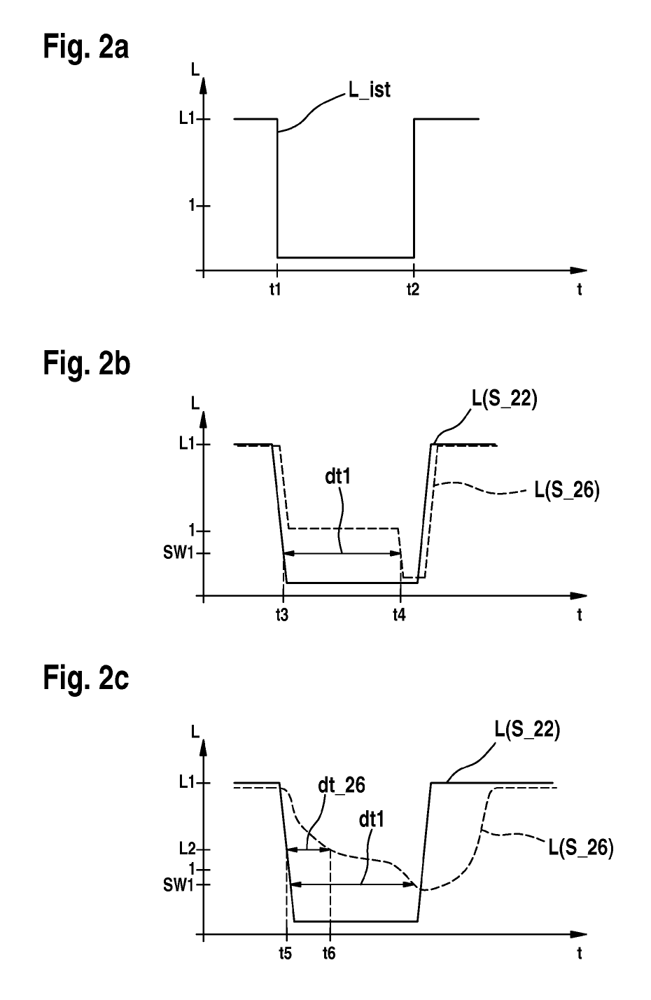

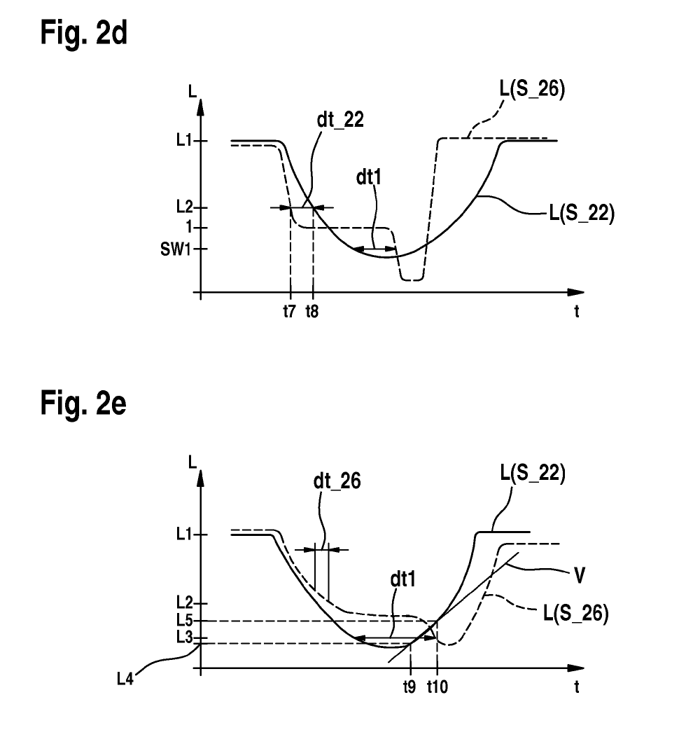

FIG. 2 illustrates courses of the air ratio L above the time t, as they occur for example under different framework conditions during the regeneration of a storage catalytic converter as catalytic converter 24. FIG. 2a shows thereby the actual air ratio L in an exhaust gas atmosphere before the NOx storage catalytic converter 24. The combustion engine 10 is operated with the air ration L>1 for the points of time left of t1. As it is generally known the ratio L is defined as the quotient of two air masses. The denominator is the air amount, which is theoretically required for a stoichiometric combustion of a certain fuel amount. The numerator is the air amount that is actually involved in the combustion. Air ratios L>1 represent therefore the air surplus, while air ratios L<1 represent a fuel surplus. According to FIG. 2a the combustion engine 10 is operated between the points of time t1 and t2 with an air ratio L<1. Subsequently, which means for points of time that are located right to t2, it is operated again with air ratios L>1. The operation with air ratios L>1 takes place for an optimization of the fuel consumption, while the operation with an air ratio L<1 takes for example place temporally for a regeneration of a storage catalytic converter as catalytic converter 24.

FIG. 2b shows like the course of the air ratio L_ist from FIG. 2a is projected in an air ratio L(S_22) and an air ratio L(S_26) at a functioning NOx storage catalytic converter 24 and unconditionally functioning exhaust gas probes 22 and 26. The air ratio L(S_22) results thereby as a function of the signal S_22 of the first exhaust gas probe 22, while the air ratio L(S_26) results as a function of the signal S_26 of the second exhaust gas probe 26.

The course of the air ratio L(S_22) projects the course of the actual air ratio L_ist from FIG. 2a with a negligible delay. The air ratio L(S_26) on the other hand falls at first down to the value 1 after the point of time t1. This behavior results from the fact that the reducing exhaust gas atmosphere at first reacts with the oxygen, which has been stored in the catalytic converter 24 before. Only when this oxygen has been consumed after the point of time dt1, an air ratio L(S_26)<1 results as well behind the catalytic converter 24.

The duration of the time span dt1 is a measure for the functionality of the catalytic converter 24. The value of dt1 gets smaller with a diminishing functionality. It is detected thereby, in that a point of time t3 is detected at first, at which the air ratio L(S_22) falls below a threshold value SW1<1, in that a point of time t4 is detected subsequently, at which the air ratio L(S_26) falls below the threshold value SW1<1, and furthermore in that dt1 is created as the difference t4−t3. In the area of air ratios L>1 the edges of the air ratio L(S_22) that has been measured before the catalytic converter 24 and the air ratio L(S_26) that has been measured behind the catalytic converter 24 fall parallel and drop in a very small interval. This behavior is typical for an unconditionally functioning exhaust gas probe 22, 26. The small interval between the falling edges results already from different running times of the exhaust gas to the corresponding position of the exhaust gas probe 22 and 26 and can be neglected at the determination of dt1.

FIG. 2c shows the effect of an inertly reacting second exhaust gas probe 26 under conditions that are unaltered otherwise. Due to the inert reaction the air ratio L(S_26) falls below the threshold value SW1 comparably late. Thereby dt1 gets longer and there is the danger that the functionality of the catalytic converter 24 is assessed as being better than it actually is. This is avoided in an embodiment of the invention thereby, in that the value of a time span dt_26 is detected at a falling edge of the air ratio s L(S_22) and L(S_26), whose values are still within the range of air ratios>1. The value dt_26 is created as difference dt_26=t6−t5 and compared to a threshold value. A checking of the functionality of the catalytic converter 24 takes not place if the value of the time span dt_26 is greater than the threshold value.

FIG. 2d shows the effects of an inertly reacting first exhaust gas probe 22. In that case the air ratio L(S_22) falls below the threshold value SW1 comparably late. As a result the time span dt1 foreshortens. Therefore the danger exists, that the functionality of the catalytic converter 24 is evaluated as being worse than it actually is. In order to avoid that a time distance dt_22=t8−t7 is detected between the points of time t7 and t8, at which the air ratios L(S_26) and L(S_22) correspond with an air ratio value L2 with L1>L2>1. A checking of the functionality does also not take place here if the value of the time span dt_22 is greater than a threshold value.

FIG. 2e shows a case, at which both exhaust gas probes 22, 26 react inertly. As FIG. 2e shows compared to FIG. 2b, a change of the time span dt1 can also be caused in this case. Therefore even in that case a danger exists that the functionality of the catalytic converter 24 is evaluated as being wrong. In distinction from the cases of FIGS. 2c and 2d the case of FIG. 2e, at which both probes react inertly, cannot reliably be detected from the courses of the falling edges of the air ratios L(S_22) and L(S_26) in the area of air ratios L>1, because the time dt_26 between the points of time, at which the air ratios L(S_22) and L(S_26) falls below the value L2, is comparably too short.

As a remedy one embodiment of the invention provides to increase the air ratio L from a fourth value L4<1 to a fifth value L5 with L4>L5>1, to detect a changing speed of the signal S_22 of the first exhaust gas probe 22 that occurs during the increase or to detect an air ratio L(S_22) that is based on that and to compare it with a further threshold value. The functionality of the catalytic converter 24 is then not checked, if the value of the time span dt_26 is smaller than the corresponding threshold value and the second threshold value is also not exceeded.

As it has already been stated above, this embodiments is based on the knowledge that the increasing edge of the air ratio L(S_22), which is detected before the catalytic converter 24, allows the evaluation of the changing speed and therefore of the inertia of the probe signal. The falling edges are on the other strongly dependent on operating points of the combustion engine and are therefore not appropriate for a reliable determination of the changing speed. This applies to the falling edges of the signal S_22 of the first exhaust gas probe 22 as well as to the falling edge of the signal S_26 of the second exhaust gas probe 26.

Compared to the evaluation of the changing speed in the signal S_22 of the first exhaust gas probe at an increasing edge the increasing edge of the signal S_26 of the second exhaust gas probe 26 has the disadvantage that it depends on the state of the catalytic converter 24.

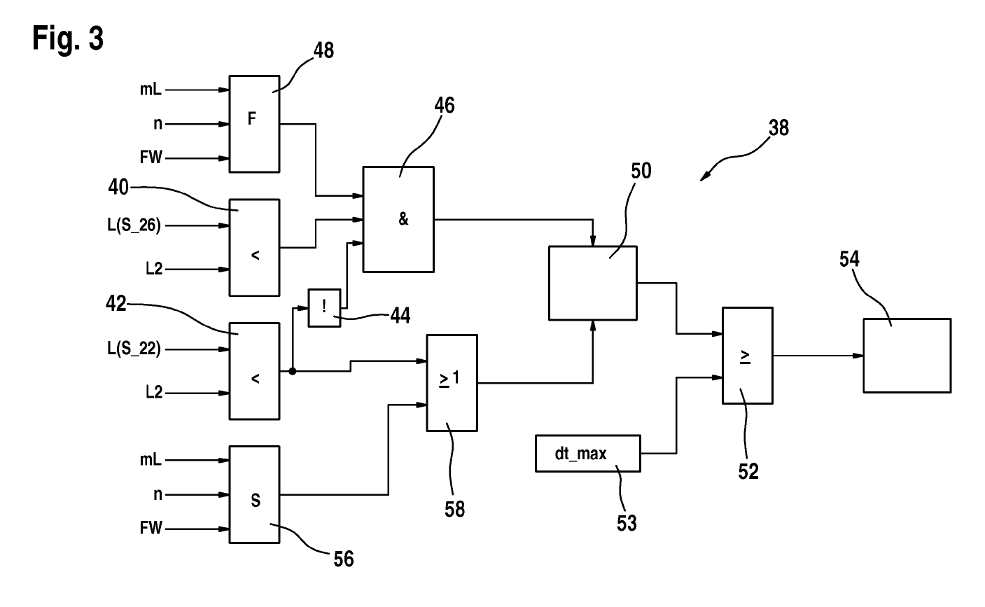

FIG. 3 shows a block circuit diagram of a signal processing structure 38 of the control unit 28, which is supplied for implementing an embodiment of the invention. FIG. 3 discloses therefore aspects of the procedure as well as aspects of the device of the present invention.

The signal processing structure 38 serves for the detection of the situation, which is shown in FIG. 2d. The signal processing structure 38 processes the signals S_22, S_26 of the exhaust gas probes 22 and 26 as input signals and/or corresponding air values L(S_22), L(S_26) and values of the air mass mL and/or the engine speed n and/or the driver's request FW. The evaluation of mL, n and FW takes thereby place for a creation of control bits F, S, with which the signal processing is releases (F=1) and/or cancelled (S=1). The signal processing is released (F=1) in a preferred embodiment if sufficiently constant values of the air mass mL and the engine speed n are present and/or if sufficiently constant values of the driver's request FW and the engine speed are present and cancelled (S=1) if insufficiently constant values of those operating parameters are present.

The air ratio L(S_26) is compared in block 40 with the threshold value L2. The air ratio L(S_22) is compared to the threshold value L2 in block 42. Block 44 represents a negation. The AND-conjunction 46 delivers then a logic one, if the control bit that is created in block 48 is F=1 (release conditions fulfilled), L(S_26) falls below the threshold value L2 and L(S_26) does not yet fall below the threshold value L2. This is the case in FIG. 2d at the point of time t7. The logical one that is supplied by the AND-gate 46 activates a time meter 50, which detects the time span dt_22. The actual value of the time span dt_22 is compared in block 52 to a threshold value dt_max, which is provided by block 53.

If dt_22 exceeds the threshold value dt_max, this shows an inert first exhaust gas probe 22 and the evaluation of the functionality of the catalytic converter 24 is blocked by the delivery of a logical 1 to block 54. The time meter 50 is stopped if L(S_22) falls below the threshold value L2 or if a termination condition (S=1) is fulfilled, which is created in block 56. The mentioned OR-conjunction of the termination condition S with the result of the comparison from block 42 takes place in the OR-conjunction 58.

An inert second exhaust gas probe 26 is detected by the signal processing structure 38, if one exchanges block 40 and 42.

For determining the changing speed of the air ratio L(S_22) or the signal S_22 of the first exhaust gas probe 22 at a new leaning between the air ratios L4 and L5 in FIG. 2e the points of time t9, t10 are detected, at which the value L4, L5 is reached. The slope of the straight line v in FIG. 2e results from the values of the air ratios L4, L5 and the time span t9, t10, which represents a measure for the changing speed.

The described procedure and/or one of its embodiments is preferably carried out at an exhaust gas after-treatment system 12 with a NOX storage catalytic converter 24 parallel to a regeneration of the NOx storage catalytic converter 24, for which a reduction of the air ratio lambda from a value<1 to a value>1 takes place. Thereby the described examinations can be carried out passively accompanying the regeneration, so that the examinations require no additional interferences into the air ratio of the lambda of the combustion engine 10. The examinations can therefore be carried in particular in an exhaust gas neutral way.

During the regeneration the time spans dt_26 and/or dt_22 are preferably detected at the reduction of the air ratio lambda, thus at the enrichment, and the changing speed v at the increase of the air ratio lambda, thus at a subsequently occurring new leaning

The second lambda value L2 lies preferably between 1.06 and 1.02 and/or the fifth lambda value L5 is located preferably between 0.92 and 0.96.

1. Method for checking the functionality of an exhaust gas after-treatment system of an internal combustion engine by evaluating signals of a first exhaust gas probe and a second exhaust gas probe, in between which a catalytic converter is arranged, wherein the air ratio L of an exhaust gas atmosphere, which streams through the exhaust gas after-treatment system, is reduced from a first lambda value L1>1 over a second lambda value L2 with L1>L2>1 on to a third lambda value L3 with L2>L3, the value of a time span is detected, which is located between the points of time at which the signals of the two exhaust gas sensors display the second value L2, the value of the time span is compared to a threshold value, and an analysis of the functionality of the catalytic converter is not carried out if the value of the time span is greater than the threshold value.

2. The method according to claim 1 wherein it is checked whether the first exhaust gas probe displays the second lambda value L2 temporally before the second exhaust gas probe and whether the time span is greater than the threshold value.

3. The method according to claim 1 wherein it is checked whether the second exhaust gas probe displays the second lambda value L2 temporally before the first exhaust gas probe and whether the time span is greater than the threshold value.

4. The method according to claim 1 wherein the air ratio is increased from a fourth lambda value L4<1 to a fifth lambda value L5 with L4<L5<1, a changing speed of the signal of the first exhaust gas probe that occurs during the increase is detected and compared to a further threshold value, and in that if the value of the time span from claim 1 is smaller than the corresponding threshold value and the further threshold value is not exceeded, a checking of the functionality of the catalytic converter is not carried out.

5. The method according to claim 1, wherein the catalytic converter is a NOx catalytic converter.

6. The method according to claim 5 wherein it is carried out during a regeneration of the NOx catalytic converter, for which a reduction of the air value lambda takes place from a value>1 to a value<1 and a subsequent increase of the air value lambda from a value<1 to a value>1.

7. The method according to claim 6 wherein the time span is detected during the reduction and in that the change speed is detected during the increase.

8. The method according to claim 6 wherein the time span of the second lambda value is located between 1.06 and 1.02 and/or the fifth lambda value between 0.92 and 0.96.

9. Control unit of a combustion engine, which provides an exhaust gas after-treatment system with a first exhaust gas probe, a second exhaust gas probe and a catalytic converter that is arranged between the two exhaust gas probes, whereby the control unit is construed to check the functionality of the exhaust gas after-treatment system by evaluating signals of the first exhaust gas probe and the second exhaust gas probe, wherein the control unit is construed to reduce the air ratio lambda of an exhaust gas atmosphere, which streams through the exhaust gas after-treatment system, is reduced from a first lambda value L1>1 over a second lambda value L2 with L1>L2>1 on to a third lambda value L3 with L2>L3, the value of a time span is detected, which is located between the points of time at which the signals of the two exhaust gas sensors display the second value L2, the value of the time span is compared to a threshold value, and an analysis of the functionality of the catalytic converter is not carried out if the value of the time span is greater than the threshold value.

10. The control unit according to claim 9 wherein it is construed to carry out a method according to claim 2 and/or to control its course.
